(19) United States
(12) Patent Application Publication
(10) Pub. No.: US 2026/0299758 A1
(43) Pub. Date: Oct. 1, 2026

(54) METHOD, APPARATUS, DEVICE, AND STORAGE MEDIUM FOR PAGE INTERACTION

(71) Applicant: Beijing Youzhuju Network Technology Co., Ltd., Beijing (CN)

(72) Inventors: Yong Liu, Beijing (CN); Tong Li, Beijing (CN); Dong Liu, Beijing (CN); Lianlun Li, Beijing (CN)

(21) Appl. No.: 19/480,752

(22) PCT Filed: Aug. 21, 2024
(86) PCT No.: PCT/CN2024/113733

§ 371 Date: Oct. 31, 2025

(30) Foreign Application Priority Data
Aug. 23, 2023 (CN) 202311070230.0

(51) Int. Cl. G06F 3/0483; G06F 3/04842; G06Q 30/0207

(52) U.S. Cl. CPC G06F 3/0483; G06F 3/04842; G06Q 30/0222

(57) ABSTRACT

Embodiments of the disclosure provide a method, an apparatus, a device, and a storage medium for page interaction, which relate to the field of computer technology. The method includes: determining a target object set in response to a selection operation for at least two preset objects in a preset object set; receiving policy setting information input for a preset policy element in a promotion policy setting page for the target object set; and generating promotion policies corresponding to respective target objects in the target object set according to the policy setting information, where in the promotion policies corresponding to different target objects, at least part of element contents of the preset policy element are same.

The present application claims priority to Chinese Patent Application No. 202311070230.0, filed on Aug. 23, 2023, and entitled “METHOD, APPARATUS, DEVICE, AND STORAGE MEDIUM FOR PAGE INTERACTION”, which is incorporated herein by reference in its entirety.

### FIELD Embodiments of the present disclosure relate to the field of computer technology and, in particular, to a method, an apparatus, a device, and a storage medium for page interaction.

### BACKGROUND

With the rapid development of information technology and the popularization of mobile internet, users may obtain various resources through various internet-related functions, such as online shopping functions, which provides great convenience for various aspects of users' lives and work.

### SUMMARY

Embodiments of the present disclosure provide a method, an apparatus, a device, and a storage medium for page interaction, which may optimize existing page interaction solutions.

In a first aspect, an embodiment of the present disclosure provides a method for page interaction, including: determining a target object set in response to a selection operation for at least two preset objects in a preset object set, where target objects in the target object set include the at least two preset objects; receiving policy setting information input for a preset policy element in a promotion policy setting page for the target object set; and generating promotion policies corresponding to respective target objects in the target object set according to the policy setting information, where in the promotion policies corresponding to different target objects, at least part of element contents of the preset policy element are same.

In a second aspect, an embodiment of the present disclosure further provides an apparatus for page interaction, including: a target object determination module configured to determine a target object set in response to a selection operation for at least two preset objects in a preset object set, where target objects in the target object set include the at least two preset objects; a setting information receiving module configured to receive policy setting information input for a preset policy element in a promotion policy setting page for the target object set; and a policy generation module configured to generate promotion policies corresponding to respective target objects in the target object set according to the policy setting information, where in the promotion policies corresponding to different target objects, at least part of element contents of the preset policy element are same.

In a third aspect, an embodiment of the present disclosure further provides an electronic device, including: one or more processors, a storage apparatus, configured to store one or more programs, when the one or more programs are executed by the one or more processors, the one or more processors are caused to perform the method for page interaction provided by the embodiment of the present disclosure.

In a fourth aspect, an embodiment of the present disclosure further provides a storage medium including computer-executable instructions that, when executed by a computer processor, the method for page interaction provided by the embodiment of the present disclosure is performed.

### BRIEF DESCRIPTION OF DRAWINGS

The foregoing and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic, and that parts and elements are not necessarily drawn to scale.

FIG. 1 is a schematic flowchart of a method for page interaction according to an embodiment of the present disclosure;

FIG. 2 is a schematic diagram of interface interaction according to an embodiment of the present disclosure;

FIG. 3 is a schematic diagram of interface interaction according to a further embodiment of the present disclosure;

FIG. 4 is a schematic flowchart of a method for page interaction according to an embodiment of the present disclosure;

FIG. 5 is a schematic diagram of still another interface interaction according to a yet further embodiment of the present disclosure;

FIG. 6 is a schematic diagram of a structure of an apparatus for page interaction according to an embodiment of the present disclosure; and

FIG. 7 is a schematic diagram of a structure of an electronic device according to an embodiment of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only for illustrative purposes and are not intended to limit the protection scope of the present disclosure.

It should be understood that the various steps described in the method implementations of the present disclosure may be performed in different orders and/or in parallel. Furthermore, the method implementations may include additional steps and/or omit the steps shown. The scope of the present disclosure is not limited in this respect.

As used herein, the term “include/comprise” and variations thereof are open-ended inclusions, that is, “include/comprise but not limited to”. The term “based on” is “at least partially based on”. The term “one embodiment” means “at least one embodiment”. The term “another embodiment” means “at least one other embodiment”. The term “some embodiments” means “at least some embodiments”. Relevant definitions of other terms will be given in the following description.

It should be noted that concepts such as “first” and “second” mentioned in the present disclosure are only used to distinguish different apparatuses, modules, or units and are not used to limit the order of functions performed by these apparatuses, modules, or units or interdependence therebetween.

It should be noted that the modifiers “one” and “a plurality of” mentioned in the present disclosure are illustrative rather than restrictive. Those skilled in the art should understand that unless otherwise clearly indicated in the context, they should be understood as “one or more”.

The names of messages or information exchanged between a plurality of apparatuses in the implementations of the present disclosure are only for illustrative purposes and are not intended to limit the scope of these messages or information.

It may be understood that before the technical solutions disclosed in the embodiments of the present disclosure are used, the user should be informed of the type, use range, use scenarios, etc., of personal information involved in the present disclosure in an appropriate manner and the authorization of the user should be obtained in accordance with relevant laws and regulations.

For example, in response to receiving an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not constitute a limitation on the implementations of the present disclosure, and other manners that satisfy the relevant laws and regulations may also be applied to the implementations of the present disclosure.

It may be understood that the data involved in the technical solution (including but not limited to the data itself, acquisition or use of the data) should comply with the requirements of corresponding laws, regulations, and related provisions.

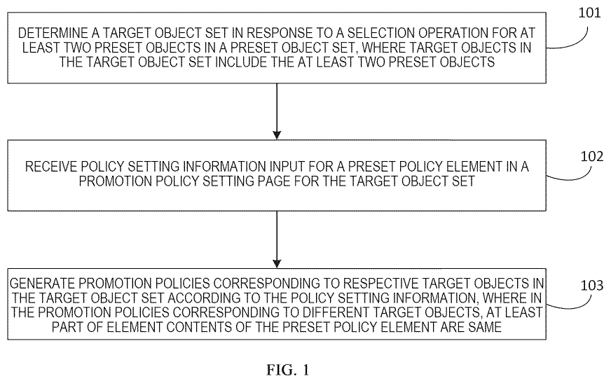

FIG. 1 is a schematic flowchart of a method for page interaction according to an embodiment of the present disclosure. The embodiment of the present disclosure may be applicable to the scenario of page interaction in the process of setting a promotion policy for a preset object. The method may be performed by an apparatus for page interaction, which may be implemented in the form of software and/or hardware. Optionally, the method is implemented by an electronic device. The electronic device may be a mobile terminal, such as a mobile phone, a smart watch, a tablet computer, or a personal digital assistant, or may be a device, such as a personal computer (PC) or a server.

As shown in FIG. 1, the method includes the followings.

At block 101, a target object set is determined in response to a selection operation for at least two preset objects in a preset object set, where target objects in the target object set include the at least two preset objects.

In the embodiments of the present disclosure, the preset object may be understood as a resource that a user may directly or indirectly obtain through a network, for example, may include a product, an item, or a service, and may be a virtual object or a physical object. With the continuous development of network technologies, users may view more and more resources through the network, and in order to help users conveniently view or obtain the resources they need, related technical solutions for online network promotion have emerged. In a network promotion scenario, a source party of the preset object may entrust a promoter to promote the preset object, and the promotion process needs to follow a promotion policy set by the provider. The source party may be understood as an operator of the preset object, for example, a merchant. The promoter may be understood as a subject that promotes the preset object, and provides a promotion service for the source party for the preset object. For example, the promoter may include a live streaming room account, a video blogger account, or a network influencer account. In the related art, the merchant needs to separately set a promotion policy for each product, and the promotion policy usually includes a plurality of policy elements, which is time-consuming and labor-intensive, and seriously affects the generation efficiency and implementation timeliness of the promotion policy.

In the embodiments of the present disclosure, the preset object set includes a plurality of preset objects. The preset object set may be understood as all preset objects that may be provided by the source party or all preset objects that are preset to participate in promotion, which may be set according to actual needs. The preset object set may be displayed on a preset page, and the preset page may be a page in a preset application corresponding to a preset platform (for example, an object promotion platform) or a client webpage corresponding to the preset platform. The user of the electronic device may be a user associated with the source party. In other words, the preset page may be displayed to the user associated with the source party, for example, a page for the merchant. The user associated with the merchant (hereinafter referred to as “merchant” for convenience of explanation) may access the preset page through a merchant account, thereby setting the promotion policy. For example, a specific display form of the preset object set is not limited, for example, it may be a list form, a matrix form, or the like. For each preset object, a selection control (such as a checkbox) may be correspondingly displayed. The merchant may input the selection operation for the preset objects in the preset object set by triggering the selection control. The display content of the preset object may include, for example, object identification information of the preset object. The object identification information of the preset object may include, for example, an object name, an object number, or an object icon. The object icon may include a physical photo, a schematic diagram, or the like of the target object.

For example, the merchant may select a certain number (less than or equal to the preset objects in the preset object set) of preset objects according to actual needs. If the selection is completed, the merchant may trigger a selection complete control, such as a “Complete” button or a “Batch Add Policy” button, and the target object set may be determined according to the preset objects currently in the selected state, i.e., the target objects in the target object set include the preset objects in the selected state. It should be noted that if the merchant only selects one preset object, the technical solution provided by the embodiment of the present disclosure may also be applied, in which case the number of target objects in the target object set may be one.

At block 102, policy setting information input for a preset policy element is received in a promotion policy setting page for the target object set.

For example, after the target object set is determined, the promotion policy setting page for the target object set may be displayed, and the merchant may set the promotion policies for the target objects in the target object set through the promotion policy setting page. Optionally, it may be switched from displaying the preset page to displaying the promotion policy setting page, or the promotion policy setting page may be displayed on an upper layer of the preset page. The size of the promotion policy setting page may be smaller than or equal to that of the preset page.

For example, the promotion policy may include at least one preset policy element, and the preset policy element may include, for example, at least one of a promoter scope, promotion feedback information, or a policy validity time range. The promoter scope may be understood as a scope of the promoter in the object promotion platform that may provide a promotion service for the target object. For example, it may be all promoters or designated promoters in the platform, and may be set by the merchant according to actual needs. The promotion feedback information may be understood as cost information that the merchant needs to pay for entrusting the promoter to provide the promotion service, such as a commission value or a commission rate. The policy validity time range may be understood as a time range during which the promotion policy remains effective. It may include an effective time and an expiration time. The time interval between the effective time and the expiration time constitutes the policy validity time range.

For example, in the promotion policy setting page, a setting input area corresponding to each preset policy element may be displayed, and after the merchant triggers a certain setting input area, the policy setting information of the corresponding preset policy element may be input through the setting input area. The policy setting information may be understood as element content set by the merchant for the preset policy element.

At block 103, promotion policies corresponding to respective target objects in the target object set are generated according to the policy setting information, where in the promotion policies corresponding to different target objects, at least part of element contents of the preset policy element are same.

For example, a promotion policy template may be preset, and the promotion policy template includes a plurality of policy elements. Optionally, the plurality of policy elements include the preset policy elements, i.e., include policy elements that allow the merchant to set through the promotion policy setting page. Optionally, the plurality of policy elements may further include template policy elements, i.e.,, policy elements with element contents set by default in the promotion policy template. After receiving the policy setting information corresponding to each preset policy element, each policy setting information may be filled into the corresponding preset policy element in the promotion policy template to generate a promotion policy corresponding to the target object set, that is, to generate promotion policies corresponding to the target objects in the target object set in batches. For example, if there are three target objects, three promotion policies may be generated in batch for the three target objects, and the promoter scopes, the promotion feedback information, and the policy validity time ranges in the three promotion policies may be all the same or partially the same.

According to the method for page interaction provided by the embodiment of the present disclosure, the target object set is determined in response to the selection operation for the at least two preset objects in the preset object set. The policy setting information input for the preset policy element is received in the promotion policy setting page for the target object set. The promotion policies corresponding to respective target objects in the target object set are generated according to the policy setting information, where in the promotion policies corresponding to different target objects, at least part of the element contents of the preset policy element are the same. With the above technical solution, when the user needs to set promotion policies for the preset objects, the user may enter the promotion policy setting page by selecting a plurality of preset objects, and input the policy setting information in the promotion policy setting page to implement batch generation of the promotion policies, which can effectively improve the efficiency of setting the promotion policies for the preset objects.

In some embodiments, the method further includes displaying, in the promotion policy setting page, object identification information corresponding to respective target objects in the target object set. In this way, when performing batch setting of the promotion policies, the merchant may conveniently view the target objects for which the current batch setting is performed without returning to the upper-level page for viewing, which can improve the convenience of inputting the policy setting information.

For example, the object identification information corresponding to the target object may include, for example, the object name, the object number, or the object icon, etc. The object icon may include the physical photo, the schematic diagram, or the like of the target object, which facilitates the merchant to more intuitively know the identity of the target object. The type of the object identification information corresponding to the target object may be the same or different from that of the object identification information corresponding to the preset object displayed on the preset page, which is not specifically limited. Optionally, the object identification information corresponding to respective target objects in the target object set may be displayed in a preset display area in the promotion policy setting page. The specific position, size, etc., of the preset display area are not limited. In the preset display area, the object identification information may be displayed horizontally, vertically, or in a matrix. When there are a large number of target objects, the object identification information of some target objects may be displayed, and the user may view more object identification information that is not currently displayed by performing a sliding gesture operation or dragging a sliding bar. Optionally, the number of target objects in the target object set, such as “xx items selected”, may be displayed in the promotion policy setting page.

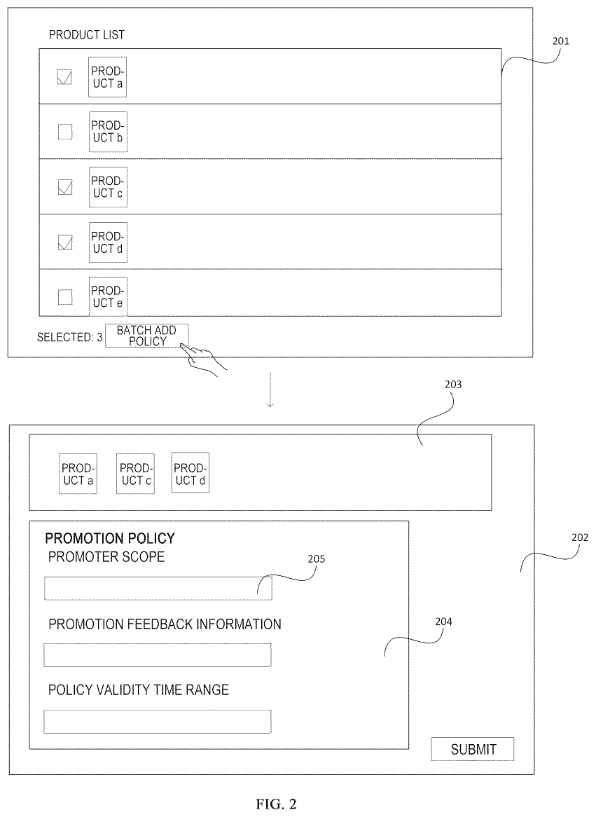

FIG. 2 is a schematic diagram of interface interaction according to an embodiment of the present disclosure. As shown in FIG. 2, a preset object set 201 is displayed on a preset page, and the preset object set 201 includes a plurality of preset objects, such as a “product a”, a “product b”, a “product c”, a “product d”, and a “product e” (there may also be “product f”, etc., not shown in the figure). The merchant may input a selection operation by triggering a checkbox on the left side of the product icon. For example, if the merchant selects “product a”, “product c”, and “product d” and triggers a “Batch Add Policy” control, it is determined that the target object set includes “product a”, “product c”, and “product d”, and a promotion policy setting page 202 for the target object set may be entered. In a preset display area 203 of the promotion policy setting page 202, object identification information, such as product icons, corresponding to respective target objects in the target object set is displayed. A setting area 204 of the promotion policy is displayed under the preset display area 203. In the setting area 204, a setting input area 205 corresponding to each preset policy element may be displayed. The merchant may input policy setting information through the setting input area 205, and after the setting is completed, the merchant may trigger batch generation of the promotion policy by triggering a “Submit” control.

In some embodiments, the method may further include: displaying at least two policy labels in the promotion policy setting page, where the at least two policy labels include a first policy label and a second policy label, the first policy label is configured to trigger display of a setting area of a promotion policy being set, the setting area is configured to receive and/or view the policy setting information, and the second policy label is configured to trigger addition of a first policy label. In this way, different promotion policies can be switched by using the policy labels in the promotion policy setting page, and new promotion policies can be added by triggering the policy label, that is, multiple different promotion policies can be set for the target object set.

For example, there may be one second policy label, and the second policy label may be understood as a control configured to trigger addition of a promotion policy to be set, and is configured to trigger the addition of the promotion policy to be set. After the second policy label is triggered, a new first policy label may be added. When entering the promotion policy setting page for the first time, one first policy label (which may be denoted as Label 1) and one second policy label (which may be denoted as Label 0) may be displayed. The first policy label may be in the triggered state, that is, the setting area of the promotion policy that currently needs to be set may be displayed. After the merchant triggers the second policy label, one first policy label (which may be denoted as Label 2) may be added. Optionally, the newly added first policy label may be set to the triggered state, that is, the setting area of the newly added promotion policy that needs to be set may be displayed. The merchant may trigger Label 1 or Label 2 to switch display of the setting areas of different promotion policies.

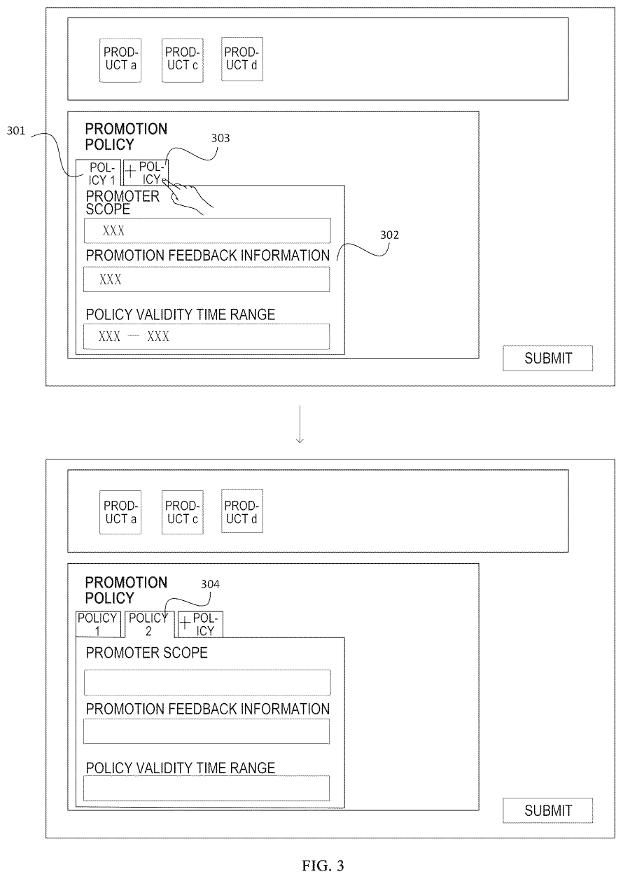

FIG. 3 is a schematic diagram of interface interaction according to a further embodiment of the present disclosure. As shown in FIG. 3, the initial first policy label 301 and the second policy label 303 are displayed in the promotion policy setting page. The initial first policy label 301 is in the triggered state, and a setting area 302 corresponding to Policy 1 is displayed. After the merchant triggers the second policy label 303, a second first policy label 304 is added, and the display position of the second policy label may move backward to be on the right side of the second first policy label 304. In this case, it may switch to display the setting area of Policy 2 corresponding to the second first policy label 304, and the merchant may set the Policy 2.

In some embodiments, the method may further include: displaying, in the promotion policy setting page, a first setting control and a second setting control corresponding to a target policy element in the preset policy element, where the first setting control is configured to trigger display of a unified setting input area of the target policy element corresponding to the target object set, and the second setting control is configured to trigger display of independent setting input areas of the target policy element corresponding to respective target objects in the target object set. Therefore, for the target policy element, both unified setting and the individual setting may be supported, such that in the process of batch setting the promotion policies, personalized setting of the target policy element can be enabled, and the flexibility of batch setting of the promotion policies can be improved.

For example, the target policy element may include some policy elements in the preset policy elements. In other words, the preset policy elements may include both preset policy elements that support personalized setting and preset policy elements that do not support personalized setting.

Optionally, in response to a trigger operation for the second setting control, the independent setting input areas of the target policy element corresponding to respective target objects in the target object set may be displayed, and preset element content may be automatically input into each of the independent setting input areas, where the element content in the independent setting input areas may be supported to be modified. Optionally, the preset element content may include default element content of the platform, or it may be element content in the unified setting input area before the second setting control is triggered. In this way, it is convenient for the user to batch set the target policy elements through minimal modification operations.

For example, the target policy element may be the promotion feedback information, such as the commission rate. The merchant may first input a commission rate of 5% in the unified setting input area. Assuming that there are 10 target objects and two of them need to have their commission rate set to 6%, after the merchant triggers the second setting control, 5% will be filled by default in each independent setting input area (such as 10 independent setting input areas), and the merchant only needs to modify the commission rate in two independent setting input areas, which can effectively improve the setting efficiency.

In some embodiments, the method further may include: displaying, in the promotion policy setting page, a reference setting trend chart corresponding to the promotion feedback information, where the reference setting trend chart includes a correspondence between different pieces of promotion feedback information and setting proportions, and the setting proportion includes a proportion of associated objects that adopt the corresponding promotion feedback information among associated objects corresponding to the target object. Taking a product as an example, in the reference setting trend chart, the abscissa represents the commission rate, and the ordinate represents the proportion of products whose commission rate is set to the corresponding abscissa value in the same products as the target product. Specifically, if there are 100 same products as the target product and the commission rate of 20 of them is set to 5%, there will be a coordinate point (5%, 20%) in the reference setting trend chart.

In some embodiments, receiving the policy setting information input for the preset policy element in the promotion policy setting page for the target object set may include receiving, in the promotion policy setting page for the target object set, setting information of a filtering condition input for the promoter scope, and determining the setting information of the filtering condition as promoter scope setting information corresponding to the target object set. Therefore, the promoter scope can be quickly set according to the filtering condition.

In some embodiments, the filtering condition may be determined according to at least one of promoter attribute information, attribute information of an object historically promoted by the promoter, or historical promotion statistics of the promoter. Therefore, the promoters can be efficiently and accurately filtered in a dimension required by the merchant.

As an example, the promoter attribute information may include, e.g., promoter level information, and the promoter level information may be measured based on the quality of the promotion service provided by the promoter, such as a sales level, and the specific measurement manner is not limited. The attribute information of the object historically promoted by the promoter may include, for example, the type of the object promoted in a recent promotion period (such as last month), such as a product category. The historical promotion statistics may include, for example, the cumulative number of objects promoted, or the cumulative value obtained from objects promoted in a promotion period (such as last month).

In some embodiments, the method may further include displaying, in the promotion policy setting page, promoter coverage information corresponding to a set promotion policy corresponding to the target object set, where the promoter coverage information may be determined according to a ratio between a target promoter scope and a preset promoter scope, and the target promotion scope may include a union of promoter scopes corresponding to the set promotion policy. Therefore, this can assist the merchant in automatically counting the promoter coverage information, and quickly and reasonably setting the promoter scope.

For example, the preset promoter scope may include all promoters of the platform. Assuming that there are 1000 promoters in total, if the set promoter scope is all promoters, the promoter coverage information is 100%. If two promotion policies have been set currently, 100 promoters are determined by the filtering condition for the promoter scope in the first promotion policy, and 200 promoters are determined by the filtering condition for the promoter scope in the second promotion policy, and there are 50 duplicate promoters in the 100 promoters and the 200 promoters, then there are 250 promoters in total, and the promoter coverage is 25%.

Optionally, the promoter scope may correspond to at least two setting modes with different priorities. When there are at least two promotion policies corresponding to promoter scopes corresponding to different setting modes in a set promotion policy set, if a target promoter is within the promoter scopes corresponding to the different setting modes at the same time, the promotion feedback information and/or the policy effective time range applicable to the target promoter may be determined according to the promotion policy to which the promoter scope with the highest priority belongs. Therefore, by setting the priorities of the promoter scopes, when the promoter scope is edited, there is no need to consider the intersection of the promoter scopes in each promotion policy, and compared with the related technical solution of setting a plurality of promotion policies without intersection of promoters, the setting efficiency can be improved, and the number of promotion policies can be effectively reduced. For example, the priority of a designated promoter scope is higher than that of a promoter scope determined according to the filtering condition, and the priority of the promoter scope determined according to the filtering condition is higher than that of all promoters.

In some embodiments, the method further may include displaying, in the promotion policy setting page, a preview image of an effective page of the promotion policy corresponding to the target object, where the effective page is configured to display to the promoter in the promotion policy corresponding to the target object. Therefore, the merchant can intuitively view the page expected to be displayed by the promoter side, which is convenient for the merchant to purposefully adjust the element content of the preset policy element by viewing the preview image of the effective page.

For example, the effective page may include object information of the target object, where the object information may include object identification information, object attribute information (taking a product as an example, for example, it may include a product description, a selling price, and a sales volume, etc.), an object association image, and the like. The effective page may further include the promotion feedback information, the policy validity time range, and the like, which is convenient for the promoter to determine whether to choose to provide a promotion service for the target object.

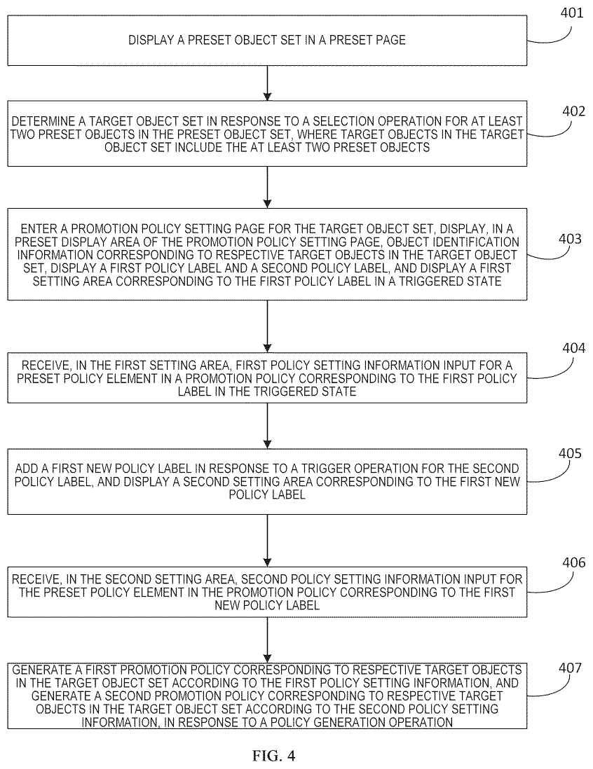

FIG. 4 is a schematic flowchart of a method for page interaction according to an embodiment of the present disclosure. The embodiment of the present disclosure is optimized based on various optional solutions in the above embodiments. Specifically, the method includes the following steps.

At block 401, a preset object set is displayed on a preset page.

For example, taking a merchant setting a promotion policy for a product as an example, a list of products provided by the merchant that require promotion may be displayed on the preset page.

At block 402, a target object set is determined in response to a selection operation for at least two preset objects in the preset object set, where target objects in the target object set include the at least two preset objects.

For example, the merchant may select from the product list a plurality of products that currently need to be set promotion policies in batch according to actual needs.

At block 403, a promotion policy setting page is entered for the target object set, object identification information corresponding to respective target objects in the target object set is displayed in a preset display area in the promotion policy setting page, a first policy label and a second policy label are displayed, and a first setting area corresponding to the first policy label in a triggered state is displayed.

For example, after the merchant completes the selection, the promotion policy setting page for the target product set may be entered, icons of the target products may be displayed in the promotion policy setting page, and the first policy label and the second policy label may be displayed. By default, one first policy label and one second policy label may be displayed, and the first policy label may be in the triggered state.

At block 404, first policy setting information input for a preset policy element in a promotion policy corresponding to the first policy label in the triggered state is received in the first setting area.

Optionally, the first setting control and the second setting control corresponding to a target policy element in the preset policy element may be displayed in the setting area.

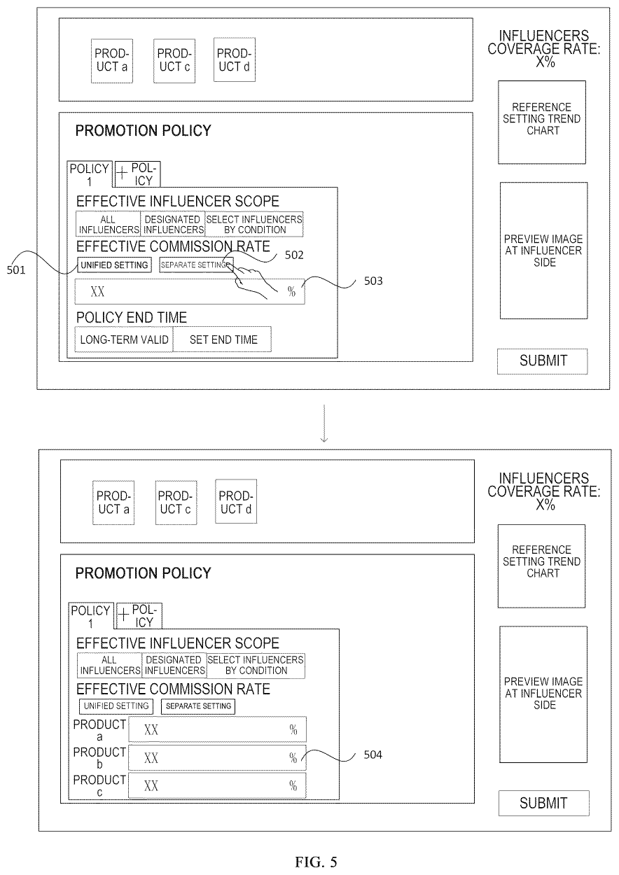

FIG. 5 is a schematic diagram of interface interaction according to a yet further embodiment of the present disclosure. As shown in FIG. 5, assuming that the target policy element is an effective commission rate, a first setting control 501 and a second setting control 502 may be correspondingly displayed, the first setting control 501 may be used for unified setting, and the second setting control 502 may be used for separate setting. By default, the first setting control 501 is in the triggered state, and a unified setting input area 503 of the commission rate is displayed. When the merchant wants to set the commission rate separately, the second setting control 502 may be triggered, and independent setting input areas 504 of the commission rate corresponding to respective target products may be displayed.

At block 405, a first new policy label is added in response to a trigger operation for the second policy label, and a second setting area corresponding to the first new policy label is displayed.

At block 406, second policy setting information input for the preset policy element in a promotion policy corresponding to the first new policy label is received in the second setting area.

At block 407, in response to a policy generation operation, a first promotion policy corresponding to respective target objects in the target object set is generated according to the first policy setting information, and a second promotion policy corresponding to respective target objects in the target object set is generated according to the second policy setting information.

For example, the merchant may add more first policy labels by triggering the second policy label. After the merchant inputs corresponding policy setting information for each promotion policy to be set, the promotion policy corresponding to each first policy label may be generated, thereby implementing batch generation of a plurality of different promotion policies for a plurality of products.

Optionally, after the promotion policy is generated, the promotion policy may be synchronized to the corresponding promoter side.

According to the method for page interaction provided by the embodiment of the present disclosure, the preset object set is displayed on the preset page, and the merchant user may input the selection operation for a plurality of preset objects in the preset object set. The target object set is determined according to the selection operation. The object identification information of the target objects and the two policy labels are displayed in the promotion policy setting page for the target object set. The policy setting information may be input for the preset policy element through the setting area of the first policy label in the triggered state, and the promotion policy to be set may be added by triggering the second policy label. After completing the setting operations of the plurality of promotion policies, a plurality of promotion policies may be generated in batch for each of the plurality of target objects, which can further effectively improve the efficiency of setting the promotion policies for the preset objects, and shorten the effective duration of the promotion policies, such that the promotion policies set by the merchant can be pushed to the corresponding promoters more quickly.

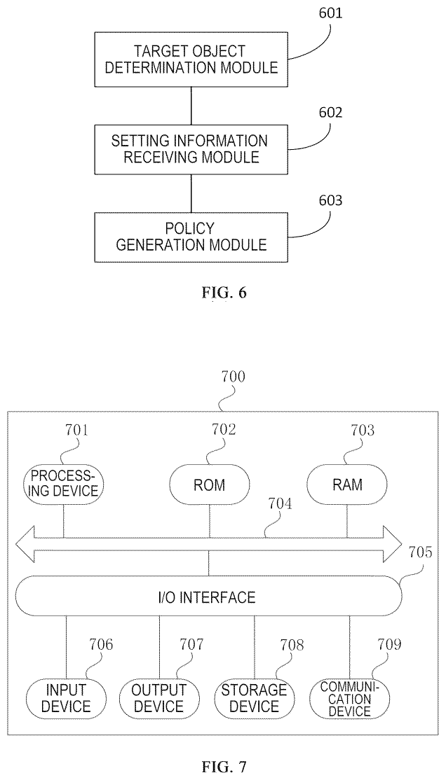

FIG. 6 is a schematic diagram of a structure of an apparatus for page interaction according to an embodiment of the present disclosure. As shown in FIG. 6, the apparatus includes: a target object determination module 601 configured to determine a target object set in response to a selection operation for at least two preset objects in a preset object set, where target objects in the target object set include the at least two preset objects; a setting information receiving module 602 configured to receive policy setting information input for a preset policy element in a promotion policy setting page for the target object set; and a policy generation module 603 configured to generate promotion policies corresponding to respective target objects in the target object set according to the policy setting information, where in the promotion policies corresponding to different target objects, at least part of element contents of the preset policy element are same.

The apparatus for page interaction provided by the embodiment of the present disclosure determines the target object set in response to the selection operation for the at least two preset objects in the preset object set, receives the policy setting information input for the preset policy element in the promotion policy setting page for the target object set, and generates the promotion policies corresponding to respective target objects in the target object set according to the policy setting information, where in the promotion policies corresponding to different target objects, at least part of the element contents of the preset policy element are the same. With the above technical solution, when the user needs to set the promotion policies for the preset objects, the user can enter the promotion policy setting page by selecting a plurality of preset objects, and input the policy setting information in the promotion policy setting page to implement the batch generation of the promotion policies, which can effectively improve the efficiency of setting the promotion policies for the preset objects.

Optionally, the preset policy element may include at least one of a promoter scope, promotion feedback information, or a policy validity time range.

Optionally, the apparatus further includes: an object identification display module configured to display, in the promotion policy setting page, object identification information corresponding to respective target objects in the target object set.

Optionally, the apparatus further includes: a label display module configured to display at least two policy labels in the promotion policy setting page, where the at least two policy labels include a first policy label and a second policy label, the first policy label is configured to trigger display of a setting area of a promotion policy being set, the setting area is configured to receive and/or view the policy setting information, and the second policy label is configured to trigger addition of a first policy label.

Optionally, the apparatus further includes: a setting control display module configured to display, in the promotion policy setting page, a first setting control and a second setting control corresponding to a target policy element in the preset policy element, where the first setting control is configured to trigger display of a unified setting input area of the target policy element corresponding to the target object set, and the second setting control is configured to trigger display of independent setting input areas of the target policy element corresponding to respective target objects in the target object set.

Optionally, the setting information receiving module includes: a setting information receiving unit configured to receive, in the promotion policy setting page for the target object set, setting information of a filtering condition input for the promoter scope, and determine the setting information of the filtering condition as promoter scope setting information corresponding to the target object set, where the filtering condition is determined according to at least one of promoter attribute information, attribute information of an object historically promoted by the promoter, or historical promotion statistics of the promoter.

Optionally, the apparatus further includes: a coverage display module configured to display, in the promotion policy setting page, promoter coverage information corresponding to a set promotion policy corresponding to the target object set, where the promoter coverage information is determined according to a ratio between a target promoter scope and a preset promoter scope, and the target promotion scope includes a union of promoter scopes corresponding to the set promotion policy.

Optionally, the apparatus further includes: a preview image display module configured to display, in the promotion policy setting page, a preview image of an effective page of the promotion policy corresponding to the target object, where the effective page is configured to display to the promoter in the promotion policy corresponding to the target object.

The apparatus for page interaction provided by the embodiment of the present disclosure may execute the method for page interaction provided by any embodiment of the present disclosure, and has corresponding functional modules and beneficial effects for executing the method.

It is worth noting that the units and modules included in the above apparatus are only divided according to functional logic, but are not limited to the above division, as long as the corresponding functions may be implemented. In addition, the specific names of the functional units are only for the convenience of distinguishing from each other, and are not configured to limit the protection scope of the embodiments of the present disclosure.

FIG. 7 is a schematic diagram of a structure of an electronic device according to an embodiment of the present disclosure. Reference is made to FIG. 7 below, which illustrates a schematic diagram of a structure of an electronic device (such as a terminal device or a server in FIG. 7) 700 suitable for implementing the embodiments of the present disclosure. The terminal device in the embodiments of the present disclosure may include, but is not limited to, mobile terminals, such as a mobile phone, a notebook computer, a digital broadcast receiver, a PDA (personal digital assistant), a tablet computer, a PMP (portable multimedia player), and an in-vehicle terminal (such as an in-vehicle navigation terminal), and fixed terminals, such as a digital TV and a desktop computer. The electronic device shown in FIG. 7 is only an example, and should not impose any limitation on the functions and the range of use of the embodiments of the present disclosure.

As shown in FIG. 7, the electronic device 700 may include a processing device (such as a central processing unit and a graphics processing unit) 701, which may perform various appropriate actions and processing according to a program stored in a read-only memory (ROM) 702 or a program loaded from a storage device 708 into a random access memory (RAM) 703. The RAM 703 further stores various programs and data required for operations of the electronic device 700. The processing device 701, the ROM 702, and the RAM 703 are interconnected by means of a bus 704. An editing/output (I/O) interface 705 is also connected to the bus 704.

Usually, the following devices may be connected to the I/O interface 705: an input device 706 including, for example, a touch screen, a touchpad, a keyboard, a mouse, a camera, a microphone, an accelerometer, and a gyroscope; an output device 707 including, for example, a liquid crystal display (LCD), a speaker, and a vibrator; the storage device 708 including, for example, a magnetic tape and a hard disk; and a communication device 709. The communication device 709 may allow the electronic device 700 to perform wireless or wired communication with other devices to exchange data. While FIG. 7 shows the electronic device 700 with various devices, it should be understood that not all the illustrated devices are necessarily implemented or included. More or fewer devices may alternatively be implemented or provided.

In particular, according to the embodiments of the present disclosure, the process described above with reference to the flowchart may be implemented as a computer software program. For example, the embodiments of the present disclosure include a computer program product, which includes a computer program carried by a non-transitory computer-readable medium, where the computer program includes program code for performing the method shown in the flowchart. In such an embodiment, the computer program may be downloaded and installed from a network through the communication device 709, or installed from the storage device 708, or installed from the ROM 702. When the computer program is executed by the processing device 701, the above-mentioned functions defined in the method of the embodiments of the present disclosure are executed.

The names of messages or information exchanged between a plurality of devices in the implementations of the present disclosure are only for illustrative purposes and are not intended to limit the scope of these messages or information.

The electronic device provided by the embodiment of the present disclosure belongs to the same inventive concept as the method for page interaction provided by the above embodiments. For the technical details not described in detail in this embodiment, reference may be made to the above embodiments, and this embodiment has the same beneficial effects as the above embodiments.

An embodiment of the present disclosure provides a computer storage medium having a computer program stored thereon, the program, when executed by a processor, causes the method for page interaction provided by the above embodiments to be performed.

An embodiment of the present disclosure provides a computer program product, including a computer program that, when executed by a processor, cause the method for page interaction provided by the above embodiments to be performed.

It should be noted that the computer-readable medium in the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, apparatus, or device, or any combination of the above. More specific examples of the computer-readable storage medium may include, but are not limited to, an electrically connected portable computer disk having one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier wave, and computer-readable program code is carried therein. The data signal propagated in this way may adopt a plurality of forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to a wire, an optical cable, an RF (radio frequency), or any suitable combination of the above.

In some implementations, the client and the server may communicate using any currently known or future developed network protocol, such as the HTTP (HyperText Transfer Protocol), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, and when the one or more programs are executed by the electronic device, the electronic device is caused to determine a target object set in response to a selection operation for at least two preset objects in a preset object set, where target objects in the target object set include the at least two preset objects; receive policy setting information input for a preset policy element in a promotion policy setting page for the target object set; and generate promotion policies corresponding to respective target objects in the target object set according to the policy setting information, where in the promotion policies corresponding to different target objects, at least part of element contents of the preset policy element are same.

The computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or a server. In the case of involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented by software or by hardware. The name of a module does not constitute a limitation on the module itself under certain circumstances, for example, the policy generation module may also be described as “a module that generates a promotion policy corresponding to the target object set according to the policy setting information”.

The functions described above herein may be at least partially performed by one or more hardware logic components. For example, without limitation, example types of hardware logic components that may be used include: a field programmable gate array (FPGA), an application specific integrated circuit (ASIC), an application specific standard product (ASSP), a system on chip (SOC), a complex programmable logical device (CPLD), and more.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include but be not limited to an electronic, magnetic, optical, electromagnetic, infrared, or semiconductor system, apparatus, or device, or any suitable combination of the above. More specific examples of the machine-readable storage medium will include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, provided is a method for page interaction, including: determining a target object set in response to a selection operation for at least two preset objects in a preset object set, where target objects in the target object set include the at least two preset objects; receiving policy setting information input for a preset policy element in a promotion policy setting page for the target object set; and generating promotion policies corresponding to respective target objects in the target object set according to the policy setting information, where in the promotion policies corresponding to different target objects, at least part of element contents of the preset policy element are same.

According to one or more embodiments of the present disclosure, the preset policy element includes at least one of a promoter scope, promotion feedback information, or a policy validity time range.

According to one or more embodiments of the present disclosure, the method further includes: displaying, in the promotion policy setting page, object identification information corresponding to respective target objects in the target object set.

According to one or more embodiments of the present disclosure, the method further includes: displaying at least two policy labels in the promotion policy setting page, where the at least two policy labels include a first policy label and a second policy label, the first policy label is configured to trigger display of a setting area of a promotion policy being set, the setting area is configured to receive and/or view the policy setting information, and the second policy label is configured to trigger addition of the first policy label.

According to one or more embodiments of the present disclosure, the method further includes: displaying, in the promotion policy setting page, a first setting control and a second setting control corresponding to a target policy element in the preset policy element, where the first setting control is configured to trigger display of a unified setting input area of the target policy element corresponding to the target object set, and the second setting control is configured to trigger display of independent setting input areas of the target policy element corresponding to respective target objects in the target object set.

According to one or more embodiments of the present disclosure, receiving the policy setting information input for the preset policy element in the promotion policy setting page for the target object set includes: receiving, in the promotion policy setting page for the target object set, setting information of a filtering condition input for a promoter scope, and determining the setting information of the filtering condition as promoter scope setting information corresponding to the target object set, where the filtering condition is determined according to at least one of promoter attribute information, attribute information of an object historically promoted by the promoter, or historical promotion statistics of the promoter.

According to one or more embodiments of the present disclosure, the method further includes: displaying, in the promotion policy setting page, promoter coverage information corresponding to a set promotion policy corresponding to the target object set, where the promoter coverage information is determined according to a ratio between a target promoter scope and a preset promoter scope, and the target promotion scope includes a union of promoter scopes corresponding to the set promotion policy.

According to one or more embodiments of the present disclosure, the method further includes: displaying, in the promotion policy setting page, a preview image of an effective page of the promotion policy corresponding to the target object, where the effective page is configured to display to a promoter in the promotion policy corresponding to the target object.

According to one or more embodiments of the present disclosure, provided is an apparatus for page interaction, including: a target object determination module configured to determine a target object set in response to a selection operation for at least two preset objects in a preset object set, where target objects in the target object set include the at least two preset objects; a setting information receiving module configured to receive policy setting information input for a preset policy element in a promotion policy setting page for the target object set; and a policy generation module configured to generate promotion policies corresponding to respective target objects in the target object set according to the policy setting information, where in the promotion policies corresponding to different target objects, at least part of element contents of the preset policy element are same.

According to one or more embodiments of the present disclosure, provided is an electronic device, including: one or more processors, a storage apparatus, configured to store one or more programs, when the one or more programs are executed by the one or more processors, the one or more processors are caused to implement the method for page interaction provided by the embodiments of the present disclosure.

According to one or more embodiments of the present disclosure, provided is a storage medium including computer-executable instructions, where when the computer-executable instructions are executed by a computer processor, the method for page interaction provided by the embodiments of the present disclosure is performed.

The above description is only preferred embodiments of the present disclosure and an explanation of the applied technical principles. Those skilled in the art should understand that the disclosed scope involved in the present disclosure is not limited to the technical solutions formed by the specific combination of the above technical features, and should also cover other technical solutions formed by any combination of the above technical features or equivalent features thereof without departing from the above disclosed concept. For example, the above features and the technical features provided in the present disclosure (but not limited to) with similar functions may be replaced each other to form a technical solution.

Furthermore, although the various operations are depicted in a particular order, this should not be understood as requiring these operations to be performed in the particular order shown or in a sequential order. Under certain circumstances, multitasking and parallel processing may be advantageous. Similarly, although the above discussion contains a number of specific implementation details, these should not be construed as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in terms specific to the structural features and/or logical actions of the method, it should be understood that the subject matter defined in the appended claims is not necessarily limited to the specific features or actions described above. Conversely, the specific features and actions described above are only example forms of implementing the claims.

1. A method for page interaction, comprising:
determining a target object set in response to a selection operation for at least two preset objects in a preset object set, wherein target objects in the target object set comprise the at least two preset objects;
receiving policy setting information input for a preset policy element in a promotion policy setting page for the target object set; and
generating promotion policies corresponding to respective target objects in the target object set according to the policy setting information, wherein in the promotion policies corresponding to different target objects, at least part of element contents of the preset policy element are same.

2. The method of claim 1, wherein the preset policy element comprises at least one of a promoter scope, promotion feedback information, or a policy validity time range.

3. The method of claim 1, further comprising:
displaying, in the promotion policy setting page, object identification information corresponding to respective target objects in the target object set.

4. The method of claim 1, further comprising:
displaying at least two policy labels in the promotion policy setting page, wherein the at least two policy labels comprise a first policy label and a second policy label, the first policy label being configured to trigger display of a setting area of a promotion policy being set, the setting area being configured to receive and/or view the policy setting information, and the second policy label being configured to trigger addition of a first policy label.

5. The method of claim 1, further comprising:
displaying, in the promotion policy setting page, a first setting control and a second setting control corresponding to a target policy element in the preset policy element, wherein the first setting control is configured to trigger display of a unified setting input area of the target policy element corresponding to the target object set, and the second setting control is configured to trigger display of independent setting input areas of the target policy element corresponding to respective target objects in the target object set.

6. The method of claim 2, wherein receiving the policy setting information input for the preset policy element in the promotion policy setting page for the target object set comprises:
receiving, in the promotion policy setting page for the target object set, setting information of a filtering condition input for a promoter scope, and determining the setting information of the filtering condition as promoter scope setting information corresponding to the target object set, wherein the filtering condition is determined according to at least one of promoter attribute information, attribute information of an object historically promoted by the promoter, or historical promotion statistics of the promoter;
and/or,
the method further comprises:
displaying, in the promotion policy setting page, promoter coverage information corresponding to a set promotion policy corresponding to the target object set, wherein the promoter coverage information is determined according to a ratio between a target promoter scope and a preset promoter scope, and the target promotion scope comprises a union of promoter scopes corresponding to the set promotion policy.

7. The method of claim 1, further comprising:
displaying, in the promotion policy setting page, a preview image of an effective page of the promotion policy corresponding to the target object, wherein the effective page is configured to display to a promoter in the promotion policy corresponding to the target object.

8. (canceled)

9. An electronic device, comprising:
one or more processors,
a storage apparatus, configured to store one or more programs,
when the one or more programs are executed by the one or more processors, the one or more processors are caused to perform operations comprising:
determining a target object set in response to a selection operation for at least two preset objects in a preset object set, wherein target objects in the target object set comprise the at least two preset objects;
receiving policy setting information input for a preset policy element in a promotion policy setting page for the target object set; and
generating promotion policies corresponding to respective target objects in the target object set according to the policy setting information, wherein in the promotion policies corresponding to different target objects, at least part of element contents of the preset policy element are same.

10. A non-transitory storage medium comprising computer-executable instructions that, when executed by a computer processor, causing operations to be performed, the operations comprising:
determining a target object set in response to a selection operation for at least two preset objects in a preset object set, wherein target objects in the target object set comprise the at least two preset objects;
receiving policy setting information input for a preset policy element in a promotion policy setting page for the target object set; and
generating promotion policies corresponding to respective target objects in the target object set according to the policy setting information, wherein in the promotion policies corresponding to different target objects, at least part of element contents of the preset policy element are same.

11. The electronic device of claim 9, wherein the preset policy element comprises at least one of a promoter scope, promotion feedback information, or a policy validity time range.

12. The electronic device of claim 9, wherein the operations further comprise:
displaying, in the promotion policy setting page, object identification information corresponding to respective target objects in the target object set.

13. The electronic device of claim 9, wherein the operations further comprise:
displaying at least two policy labels in the promotion policy setting page, wherein the at least two policy labels comprise a first policy label and a second policy label, the first policy label being configured to trigger display of a setting area of a promotion policy being set, the setting area being configured to receive and/or view the policy setting information, and the second policy label being configured to trigger addition of a first policy label.

14. The electronic device of claim 9, wherein the operations further comprise:
displaying, in the promotion policy setting page, a first setting control and a second setting control corresponding to a target policy element in the preset policy element, wherein the first setting control is configured to trigger display of a unified setting input area of the target policy element corresponding to the target object set, and the second setting control is configured to trigger display of independent setting input areas of the target policy element corresponding to respective target objects in the target object set.

15. The electronic device of claim 11, wherein receiving the policy setting information input for the preset policy element in the promotion policy setting page for the target object set comprises:
receiving, in the promotion policy setting page for the target object set, setting information of a filtering condition input for a promoter scope, and determining the setting information of the filtering condition as promoter scope setting information corresponding to the target object set, wherein the filtering condition is determined according to at least one of promoter attribute information, attribute information of an object historically promoted by the promoter, or historical promotion statistics of the promoter;
and/or,
the operations further comprise:
displaying, in the promotion policy setting page, promoter coverage information corresponding to a set promotion policy corresponding to the target object set, wherein the promoter coverage information is determined according to a ratio between a target promoter scope and a preset promoter scope, and the target promotion scope comprises a union of promoter scopes corresponding to the set promotion policy.

16. The electronic device of claim 9, wherein the operations further comprise:
displaying, in the promotion policy setting page, a preview image of an effective page of the promotion policy corresponding to the target object, wherein the effective page is configured to display to a promoter in the promotion policy corresponding to the target object.

17. The non-transitory storage medium of claim 10, wherein the preset policy element comprises at least one of a promoter scope, promotion feedback information, or a policy validity time range.

18. The non-transitory storage medium of claim 10, wherein the operations further comprise:
displaying, in the promotion policy setting page, object identification information corresponding to respective target objects in the target object set.

19. The non-transitory storage medium of claim 10, wherein the operations further comprise:
displaying at least two policy labels in the promotion policy setting page, wherein the at least two policy labels comprise a first policy label and a second policy label, the first policy label being configured to trigger display of a setting area of a promotion policy being set, the setting area being configured to receive and/or view the policy setting information, and the second policy label being configured to trigger addition of a first policy label.

20. The non-transitory storage medium of claim 10, wherein the operations further comprise:
displaying, in the promotion policy setting page, a first setting control and a second setting control corresponding to a target policy element in the preset policy element, wherein the first setting control is configured to trigger display of a unified setting input area of the target policy element corresponding to the target object set, and the second setting control is configured to trigger display of independent setting input areas of the target policy element corresponding to respective target objects in the target object set.

21. The non-transitory storage medium of claim 17, wherein receiving the policy setting information input for the preset policy element in the promotion policy setting page for the target object set comprises:
receiving, in the promotion policy setting page for the target object set, setting information of a filtering condition input for a promoter scope, and determining the setting information of the filtering condition as promoter scope setting information corresponding to the target object set, wherein the filtering condition is determined according to at least one of promoter attribute information, attribute information of an object historically promoted by the promoter, or historical promotion statistics of the promoter;
and/or,
the operations further comprise:
displaying, in the promotion policy setting page, promoter coverage information corresponding to a set promotion policy corresponding to the target object set, wherein the promoter coverage information is determined according to a ratio between a target promoter scope and a preset promoter scope, and the target promotion scope comprises a union of promoter scopes corresponding to the set promotion policy.
